(19) United States
(12) Patent Application Publication
(10) Pub. No.: US 2024/0336826 A1
(43) Pub. Date: Oct. 10, 2024

(54) PLASMONIC MATERIAL, A SOLAR ABSORBER CONTAINING THE PLASMONIC MATERIALS, PREPARATION AND APPLICATION THEREOF

(71) Applicant: City University of Hong Kong Shenzhen Futian Research Institute, Shenzhen (CN)

(72) Inventors: Jian LU, Shenzhen (CN); Yingxian CHEN, Shenzhen (CN); Weihui OU, Shenzhen (CN)

(21) Appl. No.: 18/450,019

(22) Filed: Aug. 15, 2023

(30) Foreign Application Priority Data
Apr. 4, 2023 (CN) 202310392377.5

(51) Int. Cl. C09K 5/14; B01J 13/00; C02F 1/14; C08K 9/02; C08L 29/04; C09C 1/62; C09C 3/06

(52) U.S. Cl. CPC C09K 5/14; B01J 13/0065; C02F 1/14; C08K 9/02; C08L 29/04; C09C 1/62; C09C 3/063; C01P 2002/82; C01P 2002/84; C01P 2004/03; C01P 2004/04; C01P 2004/16; C01P 2004/80; C01P 2006/32; C02F 2103/08; C02F 2201/009; C08K 2201/011; C08L 2312/00

(57) ABSTRACT

A plasmonic material, a solar absorber containing the plasmonic materials, and preparation and application thereof. The plasmonic material is a material with a core-shell structure in which the core is a noble metal nanomaterial and the shell layer is non-stoichiometric copper sulfide with the general formula Cu₂₋ₓS, where 0<x≤1. The plasmonic materials can broaden the absorption bandwidth by combining and coupling the plasmonic absorption of noble metal nanomaterial in visible light and the plasmonic absorption of copper sulfide in near-infrared light. The absorption can be broadened and enhanced without sacrificing the absorption intensity with only a small amount of metal nanoparticles, thus enhancing photothermal conversion and accelerating water evaporation The solar absorber containing the plasmonic materials has a fast water evaporation rate under sunlight.

### CROSS-REFERENCE TO REPLATED APPLICATION

The present application claims the priority of the prior application No. CN 202310392377.5 submitted to China National Intellectual Property Administration on Apr. 4, 2023, which is entitled “A plasmonic material, a solar absorber containing the plasmonic materials, preparation and application thereof”. The content of the prior application is incorporated herein by reference in its entirety.

### TECHNICAL FIELD

The present disclosure belongs to the technical field of new energy utilization technology, and particularly concerns a plasmonic material, a solar absorber containing the plasmonic materials, and preparation and application thereof.

### BACKGROUND

Due to the increasing global water scarcity, solar-driven interfacial desalination is a promising technology, which uses clean and renewable energy to supply potable fresh water. A key component of this technology is the solar absorber, which is responsible for absorbing sunlight and converting light energy into heat. For this purpose, many solar absorber materials have been developed, including carbon, semiconductors, polymers, and plasmonic materials. Among others, the plasmonic noble metal nanomaterials have exceptionally strong light absorption capacity and high photothermal conversion efficiency due to their localized surface plasmon resonance effect. The plasmon is the collective oscillations of free charge carriers in response to incident light, which greatly enhances the material-light interaction and results in very large light absorption cross sections for plasmonic materials. The non-radiative decay of plasmons produces high-energy hot carriers, which can rapidly raise the temperature of the crystal lattice and surrounding medium through the electron/phonon and phonon/phonon couplings. As a result, optical energy is highly efficiently converted into thermal energy by plasmonic materials. However, noble metal nanospheres's plasmonic absorption bandwidth is intrinsically narrow, and usually limited to visible light, which only accounts for ˜47% of the solar spectrum and has low energy utilization for sunlight.

So far, various strategies have been proposed to broaden the absorption bandwidth of noble metal nanoparticles, including: i) extending the light absorption to the near-infrared region by adjusting their geometry, assembly state and surrounding dielectric environment; ii) assembling a large number of noble metal nanoparticles within a porous substrate to broaden the absorption peak by plasmonic hybridization. However, these methods either have limited broadening of the absorption bandwidth or reduce the absorption intensity while broadening the absorption bandwidth, and require a large number of noble metal particles, which is costly.

### SUMMARY

In order to solve the above problem, the present disclosure provides a plasmonic material, which is used to broaden the absorption bandwidth of noble metal nanoparticles within the solar spectrum using plasmon coupling, and achieves the full spectrum absorption of solar light (300-2500 nm) using only a small amount of plasmonic noble metal nanoparticles.

The present disclosure also provides solar light absorbers containing the above-mentioned plasmonic materials and realizes practical applications in solar-driven interfacial seawater desalination.

Specifically, the present disclosure provides the following scheme:

A plasmonic material, the materials have a core-shell structure, the core in the core-shell structure is a noble metal nanomaterial and the shell layer is non-stoichiometric copper sulfide with the general formula Cu₂₋ₓS, wherein, 0<x≤1.

The present disclosure also provides a method for manufacturing the plasmonic materials, which comprises the following steps:
1) preparing a noble metal nanomaterial colloid;
2) adding raw materials for preparing copper sulfide to the colloid prepared in step 1), reacting, and obtaining plasmonic materials.

The present disclosure also provides a solar absorber comprising the plasmonic materials.

The present disclosure further provides a method of preparing the solar absorber, the preparation method comprising:
dispersing the plasmonic materials in water to obtain a colloid of the plasmonic materials;
Blending said plasmonic materials colloid into the raw material for preparing the hydrogel, cross-linking the gel in situ, and obtaining said solar absorber.

The present disclosure also provides the application of said plasmonic materials or said solar absorber in seawater desalination.

### Beneficial Effects of the Present Disclosure

(1) The present disclosure designs a plasmonic material, which achieves broad absorption without sacrificing the absorption intensity with only a small amount of noble metal nanomaterials by combining and coupling the plasmonic absorption of noble metal nanomaterials in visible light and the plasmonic absorption of copper sulfide in near-infrared light, thus enhancing photothermal conversion and accelerating water evaporation.

(2) The present disclosure uses plasmon coupling to broaden the absorption bandwidth of noble metal nanomaterials within the solar spectrum, i.e., uses a small amount of plasmonic noble metal nanomaterials to achieve the full spectrum absorption of solar light (300-2500 nm), and proposes a solar absorber based on this strategy, The solar absorber shows at least about 90% absorption in the wavelength range of 300 to 2500 nm. The solar absorber of the present disclosure has a fast water evaporation rate under sunlight and can be an ideal material for solar-driven interfacial desalination, offering great promise for the shortage of clean drinking water sources.

### BRIEF DESCRIPTION OF THE ATTACHED DRAWINGS

FIG. 1 shows a schematic diagram of the structure of the plasmonic material Au NR@Cu₇S₄.

FIGS. 2A-2D show the synthesis and characterization of Au NR@Cu₇S₄ core-shell nanomaterials;

FIG. 2A, Schematic illustration of Au NR@Cu₇S₄ synthesis process;

FIG. 2B, Typical TEM image of Au NR@Cu₇S₄ nanomaterials;

FIG. 2C, High-resolution TEM image of Au NR@Cu₇S₄ nanomaterial, where the lattice spacings of 0.204 nm, 0.270 nm and 0.297 nm correspond to the Au(200), Cu₇S₄(221) and Cu₇S₄ (212) facets, respectively; and

FIG. 2D, High-angle annular dark-field scanning transmission electron microscopy (HAADF-STEM) and energy-dispersive X-ray spectroscopy (EDS) elemental mapping images of a single Au NR@Cu₇S₄ nanomaterial.

FIGS. 3A-3E show the optical and photothermal properties of Au NR@ Cu₇S₄ nanomaterial;

FIG. 3A, extinction spectra of Au NR, Cu₇S₄, Au NR+Cu₇S₄ (physical mixture of Au NR and Cu₇S₄) and Au NR@ Cu₇S₄ colloids (Au concentrations were all 10 g mL⁻¹);

FIG. 3B, Absorbance spectra of Au NR, Cu₇S₄ and Au NR@ Cu₇S₄ dispersed in water simulated by finite-difference time-domain method;

FIG. 3C, Electric field distribution of Au NR@ Cu₇S₄ colloid at 875 nm and Au NR colloid at 785 nm simulated by the finite-difference time-domain method;

FIG. 3D, Absorption spectra of Au NR@ Cu₇S₄, Au NR and Cu₇S₄ solar absorbers (Approximately 4 mm thick) with the bottom showing an air mass 1.5 global solar spectrum (AM 1.5G);

FIG. 3E, Temperature changes of freeze-dried Au NR@Cu₇S₄, Au NR and Cu₇S₄ solar absorbers under 1 sun irradiation (1 kW m⁻²); and

FIG. 3F, Infrared thermal images of the freeze-dried blank hydrogel, Au NR@Cu₇S₄, Au NR, and Cu₇S₄ solar absorbers under 1 sun irradiation in equilibrium.

FIG. 4 shows the extinction spectra of the plasmonic material Au NR@ Cu₇S₄ colloids synthesized with 0 μL, 25 μL, 100 μL, 200 μL, 400 μL and 500 μL Cu(Ac)₂.

FIG. 5 shows the scanning electron micrographs of the plasmonic material Au NR@ Cu₇S₄ prepared with different Cu(Ac)₂ dosages. a to d show Au NR@ Cu₇S₄ synthesized with 25 μL Cu(Ac)₂, 100 μL Cu(Ac)₂, 200 μL Cu(Ac)₂, and 400 μL Cu(Ac)₂, respectively.

FIG. 6 shows the peak positions and full width at half maximum of the longitudinal plasmon resonance modes of Au NR, Au NR+Cu₇S₄, and Au NR@ Cu₇S₄ colloids.

FIG. 7 shows the Au 4f spectrum in the X-ray photoelectron spectra of Au NR@ Cu₇S₄ and Au NR colloids.

FIG. 8 shows the scanning electron microscope image of the solar absorber containing Au NR@ Cu₇S₄ after freeze-drying.

FIG. 9A shows the reflection spectra and FIG. 9B transmission spectra of Au NR@ Cu₇S₄, Au NR and Cu₇S₄ solar absorber (Thickness approximately 4 mm).

FIG. 10 shows a photograph of a fully swollen blank hydrogel.

FIGS. 11A-11F show the solar-driven interfacial water evaporation properties of the solar absorber.

FIG. 11A Mass loss of water with time when evaporating water with blank hydrogel, deionized water, Au NR, Cu₇S₄, or Au NR@ Cu₇S₄ solar absorber under 1 sun irradiation;

FIG. 11B Temperature variation of Au NR, Cu₇S₄ or Au NR@ Cu₇S₄ solar absorber during water evaporation under 1 sun irradiation;

FIG. 11C Comparison graph of evaporation rate and energy efficiency of Au NR, Cu₇S₄, or Au NR@Cu₇S₄ solar absorbers under 1 sun irradiation. Each error bar represents the standard deviation of at least 3 data points;

FIG. 11D Raman spectra of blank hydrogel and FIG. 11E Au NR@ Cu₇S₄ solar absorber after water absorption; and

FIG. 11F Comparison of Au cost efficiency of Au NR@Cu₇S₄ solar absorber with previously reported Au-based solar absorbers for solar-driven interfacial water evaporation.

FIG. 12 shows the differential scanning calorimetry melting curves of blank hydrogel and deionized water.

FIG. 13 shows the mass change of seawater with time for Au NR@ Cu₇S₄ solar absorber for evaporation of seawater under 1 sun irradiation.

FIGS. 14A and 14B show the solar-driven interfacial desalination schematic and performance graph.

FIG. 14A Schematic diagram of the solar-driven interfacial desalination experiment; and

FIG. 14B Concentrations of Na⁺, Mg²⁺, Ca²⁺ and K⁺ in raw seawater before desalination and condensate after desalination with Au NR@ Cu₇S₄ solar absorber under 1 sun irradiation. The gray dashed line indicates the maximum salinity allowed by the WHO drinking water standard.

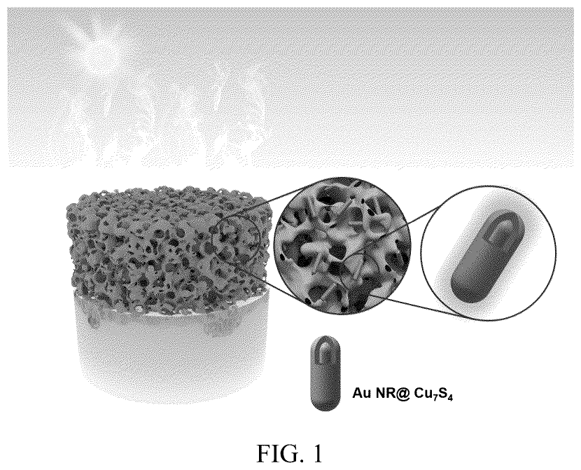

### DETAILED DESCRIPTION

### [Plasmonic Materials]

As previously described, the present disclosure provides a plasmonic material with a core-shell structure in which the core is a noble metal nanomaterial and the shell layer is a non-stoichiometric copper sulfide with the general formula Cu₂₋ₓS, wherein, 0<x≤1.

The plasmonic materials of the present disclosure, by combining and coupling the plasmonic absorption of noble metal nanomaterials in visible light and the plasmonic absorption of copper sulfide in near-infrared light, can broaden the absorption bandwidth without sacrificing the absorption intensity while using only a small amount of noble metal nanomaterials, and specifically can achieve the full spectrum (300 nm to 2500 nm) absorption of sunlight.

In some specific embodiments, the chemical formula of copper sulfide can be Cu₇S₄ or CuS.

In some specific embodiments, the noble metal nanomaterial is noble metal nanoparticles and/or noble metal nanorods.

In some specific embodiments, the noble metal is selected, for example, from at least one of gold Au, silver μg, ruthenium Ru, rhodium Rh, palladium Pd, osmium Os, iridium Ir, platinum Pt, etc.

Specifically, said noble metal is selected from Au.

In some specific embodiments, the noble metal nanomaterial is an Au nanorod, noted as Au NR.

In some specific embodiments, the shell is all wrapped around the surface of the core. Specifically, the shell layer has a thickness from 5 nm-16 nm.

In some specific embodiments, the core is in the form of a nanorod, specifically, having a length of 66 nm-70 nm and a diameter of 14 nm-21 nm.

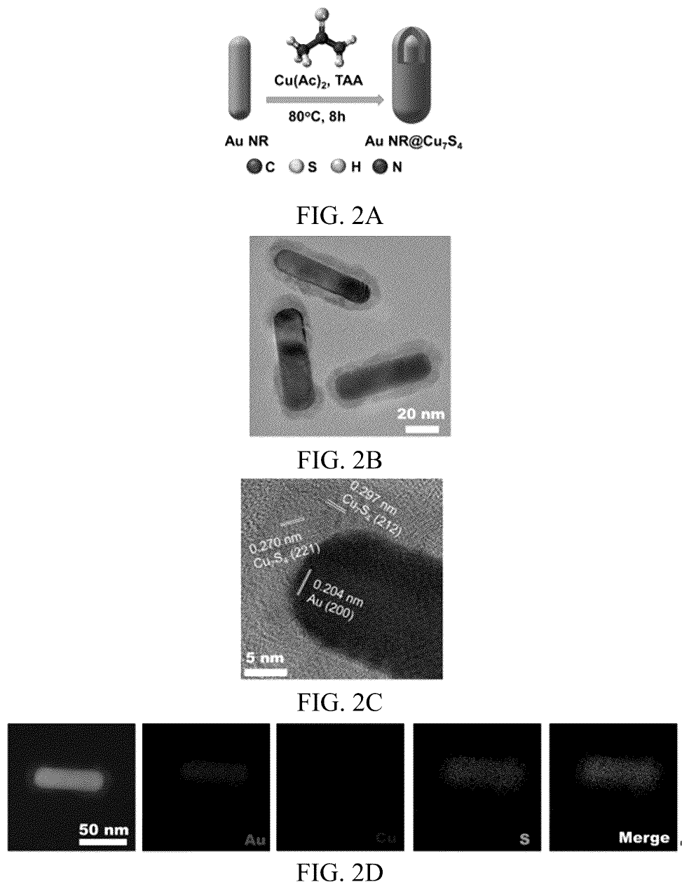

In some specific embodiments, the plasmonic material has a structure as shown in FIG. 2C, with a lattice spacing of 0.204 nm in the core corresponding to the face-centered cubic Au(200) plane; and 0.27 nm and 0.297 nm in the shell layer corresponding to the Cu₇S₄ (221) and Cu₇S₄ (212) planes, respectively.

In some specific embodiments, the plasmonic materials have high-angle annular dark-field scanning transmission electron microscopy and energy dispersive X-ray spectroscopy elemental mapping images as shown in FIG. 2D.

### [Preparation of the Plasmonic Materials]

As previously described, the present disclosure also provides a method for the preparation of plasmonic materials, the method comprising the steps of:
1) preparing noble metal nanomaterial colloids;
2) adding raw materials for preparing copper sulfide to the noble metal nanomaterial colloid prepared in step 1), reacting, and obtaining the plasmonic materials.

In some specific embodiments, step 1) specifically comprises:
11) mixing an aqueous solution of the noble metal compound with an aqueous solution of a cationic ammonium compound, adding it to an aqueous solution of the reducing agent, stirring, and keeping it for a period of time to obtain a seed solution;
12) adding the aqueous solution of the noble metal compound, the aqueous solution of silver nitrate, the aqueous solution of the metal ion complexing agent and the above prepared seed solution to the aqueous solution of the cationic ammonium compound in turn, standing, centrifuging and dispersing in water to obtain the noble metal nanomaterial colloid.

In some specific embodiments, the cationic ammonium compound is selected, for example, from at least one of cetyltrimethylammonium bromide (CTAB), tetradecyltrimethylammonium bromide, and dodecyltrimethylammonium bromide.

In some specific embodiments, the reducing agent is selected, for example, from borohydrides, and also specifically, for example, from sodium borohydride.

In some specific embodiments, the metal ion complexing agent is L-ascorbic acid.

Specifically, the step 1) comprises:
11) mixing an aqueous HAuCl₄ solution with an aqueous cetyltrimethylammonium bromide (CTAB) solution, then quickly adding an ice-cold aqueous borohydride solution, stirring, and holding the solution under a water bath at 25-35° C. for a period of time to obtain a seed solution;
12) Adding HAuCl₄ aqueous solution, silver nitrate aqueous solution, L-ascorbic acid aqueous solution and the above prepared seed solution to cetyltrimethylammonium bromide aqueous solution in turn, placing the mixture in a 25-35° C. water bath for 10-24 h, centrifuging and dispersing in deionized water to obtain the noble metal nanomaterial colloid.

In some specific embodiments, in the step 11), the molar ratio of noble metal compound, cationic ammonium compound and reducing agent in said aqueous solution of noble metal compound, aqueous solution of cationic ammonium compound and aqueous solution of reducing agent is 1.25:(50˜1000):3; specifically, it can be 1.25:500:3.

For example, the molar ratio of HAuCl₄, cetyltrimethylammonium bromide and borohydride in said aqueous solution of HAuCl₄ to aqueous solution of cetyltrimethylammonium bromide and aqueous solution of borohydride is 1.25:(50˜1000):3; specifically, it may be 1.25:500:3.

Specifically, the aqueous solution of reducing agent (specifically, such as an aqueous solution of borohydride) has a molar concentration of 0.01 M.

Specifically, the aqueous solution of borohydride is an aqueous solution of sodium borohydride.

In some specific embodiments, in step 11), after stirring the mixed solution at 1000-1500 rpm for 1-5 minutes, the solution is kept under a water bath at 25-35° C. for a period of time (e.g. 1-3 h) to obtain a seed solution.

Specifically, the solution is stirred at 1200 rpm for 2 minutes and then held in a 30° C. water bath for 2 hours to obtain the seed solution.

In some specific embodiments, the concentration of the noble metal (e.g., gold) in noble metal nanomaterial colloid is 250 to 300 μg/mL.

In some specific embodiments, in step 12), the aqueous silver nitrate solution guides the longitudinal growth of the gold nanorods and regulates the length-to-diameter ratio of the nanorods.

In some specific embodiments, in step 12), the aqueous HAuCl₄ solution, aqueous silver nitrate solution, aqueous L-ascorbic acid solution, seed solution and aqueous cetyltrimethylam-monium bromide (CTAB) solution have a volume ratio of 2:0.4:0.32:(0.096˜0.15):40; for example, 2:0.4:0.32:0.128:40.

Specifically, the molar concentration of aqueous HAuCl₄ solution is 0.01 M, the molar concentration of aqueous CTAB solution is 0.1 M, the molar concentration of said aqueous silver nitrate solution is 0.01 M, and the molar concentration of said aqueous L-ascorbic acid solution is 0.1 M.

In some specific embodiments, in step 2), the raw material for preparing copper sulfide includes a copper source and a sulfur source.

Specifically, the copper source is selected from at least one of copper acetate Cu(Ac)₂, Cu(NO₃)₂, or CuCl₂.

Specifically, said sulfur source is selected from thioacetamide.

Specifically, said copper source and sulfur source have a molar ratio of 1:1.

In some specific embodiments, in step 2), the raw material for preparing copper sulfide further comprises at least one of a surfactant, a metal ion complexing agent and a pH adjuster.

Specifically, the surfactant is cetyltrimethylammonium bromide (CTAB), tetradecyltrimethylammonium bromide, and dodecyltrimethylammonium bromide; the metal ion complexing agent is L-ascorbic acid, and the pH adjuster is hexamethylenetetramine.

Among them, CTAB is used as a surfactant to help form stable and uniformly dispersed colloids to prevent agglomeration and form micelles to guide the longitudinal growth of gold nanorods. L-ascorbic acid complexes with metal ions to guide the formation of core-shell structures.

Hexamethylenetetramine regulates pH and guides the formation of the core-shell structure.

In some specific embodiments, in step 2), the molar ratio of cetyltrimethylammonium bromide, L-ascorbic acid and hexamethylenetetramine is 8:1:2˜1:1:1, e.g., 4:1:2, in the raw materials used to prepare copper sulfide.

In some specific embodiments, the step 2) specifically comprises: Adding an aqueous solution of cetyltrimethylammonium bromide, an aqueous solution of L-ascorbic acid and an aqueous solution of hexamethylenetetramine to the noble metal nanomaterial colloid, adding an aqueous solution of thioacetamide and an aqueous solution of Cu(Ac)₂ and slowly shaking up and down to mix, placing the resulting mixture in an oven for a period of time, cooling down and then centrifuging and dispersing in deionized water to obtain the plasmonic material.

In some specific embodiments, in step 2), the molar ratio of cetyltrimethylammonium bromide, L-ascorbic acid and hexamethylenetetramine, thioacetamide, and Cu(Ac)₂ is 400:100:200:4:1˜100:25:50:1:4; for example, 100:25:50:1:1.

Specifically, the molar concentration of aqueous cetyltrimethylammonium bromide solution is 0.1 M.

Specifically, the molar concentration of aqueous thioacetamide solution is 0.1 M; the molar concentration of aqueous Cu(Ac)₂ solution is 0.1M; the molar concentration of aqueous hexamethylenetetramine solution is 0.1M; and the molar concentration of aqueous L-ascorbic acid solution is 0.1M.

In some specific embodiments, the aqueous Cu(Ac)₂ solution is added in an amount of 25 to 400 μL. In some specific embodiments, the resulting mixture is placed in an oven at 70-90° C. for 6-10 hours. For example, the resulting mixture is placed in an oven at 80° C. for 8 hours.

In some specific embodiments, the concentration of gold in the plasmonic materials is 200-250 μg/mL.

### [The Solar Absorber]

As previously described, the present disclosure also provides a solar absorber, which comprising the plasmonic materials described above.

In some specific embodiments, the solar absorber is a complex of plasmonic materials and a hydrogel.

Specifically, the plasmonic materials is dispersed inside of the hydrogel.

In some specific embodiments, the solar absorber is loaded with 25-30 μg cm⁻² of noble metals (e.g. Au, etc.).

In some specific embodiments, the solar absorber shows at least 90% absorption in the wavelength range of 300 to 2500 nm.

### [Preparation Method of Solar Absorber]

As previously described, the present disclosure also provides a preparation method of the above-mentioned solar absorber, which comprises:
dispersing the plasmonic materials in water to obtain a plasmonic materials colloid;
Blending the plasmonic materials colloid into the raw material for preparing the hydrogel, cross-linking the gelation in situ, and obtaining the solar absorber.

In some specific embodiments, the raw materials for preparing the hydrogel include polyvinyl alcohol, polyacrylamide, polyvinyl alcohol and chitosan.

Specifically, the raw materials for preparing the hydrogel are polyvinyl alcohol and chitosan.

In some specific embodiments, the method specifically comprises:
dispersing the plasmonic materials in water to obtain the plasmonic materials colloid;
dissolving polyvinyl alcohol and chitosan in deionized water containing hydrochloric acid solution to obtain a polyvinyl alcohol/chitosan solution;
Adding glutaraldehyde solution and the plasmonic materials colloid to the above polyvinyl alcohol/chitosan solution, stirring and sonicating, and standing, to obtain a hydrogel containing the plasmonic materials;
Freeze-drying the hydrogel to obtain solar absorber.

For example, immersed the hydrogel in deionized water to remove unreacted impurities, placed in −20° C. to −40° C. and frozen for 2 to 5 hours, thawed in deionized water at 28 to 32° C. for 25 to 35 minutes, repeated 2 to 5 times, and finally freeze-dried to obtain the solar absorber.

In some specific embodiments, the mass ratio of polyvinyl alcohol and chitosan is 9:1˜4:1; for example 17:3.

Preferably, the ratio of the glutaraldehyde solution and plasmonic materials colloid, polyvinyl alcohol/chitosan solution is 2:25:50, the glutaraldehyde solution concentration is 10 wt %.

### [Application of Plasmonic Materials and Solar Absorber]

The present disclosure also provides an application of plasmonic materials or solar absorber in seawater desalination.

The technical solutions of the present disclosure will be described in further detail below in connection with the accompanying drawings and specific embodiments. It should be understood that the following embodiments are intended to illustrate and explain the invention only exemplarily and should not be construed as limiting the scope of protection of the invention. Any technology implemented based on the above elements of the present invention is covered by the scope of protection intended by the present invention.

Unless otherwise stated, the raw materials and reagents used in the following embodiments are commercially available commodities or can be prepared by known methods.

### Control Sample 1

Cu₇S₄ Colloid Preparation:

Added CTAB (10 mL, 0.1 M), L-ascorbic acid (2.5 mL, 0.1 M) and HMT (5 mL, 0.1 M) to 5 mL of deionized water. Added TAA (100 μL, 0.1 M) and Cu(Ac)₂ (100 μL, 0.1 M) solutions and mixed thoroughly by slowly up and down shaking. Kept the mixture in an oven at 80° C. for 8 hours. After cooling down, centrifuged (7000 rpm, 10 min) and dispersed in deionized water to obtain Cu₇S₄ colloids.

### Control Sample 2

Au NR+Cu₇S₄ (Physical Mixture) Colloid Preparation:

A certain amount of Au NR colloid prepared in Example 1 and the Cu₇S₄ colloid solution prepared in Control sample 1 were mixed thoroughly by slowly shaking up and down in a mass ratio of 2:1, then centrifuged (7000 rpm, 7 min) and redispersed in deionized water to obtain Au NR+Cu₇S₄ colloid.

### Example 1

### Preparation and Testing of the Plasmonic Materials

### 1) Au Nanorod Colloid (Au NR):

Mixed HAuCl₄ aqueous solution (0.01 M, 0.125 mL) with cetyltrimethylammonium bromide (CTAB) aqueous solution (0.1 M, 5 mL), then quickly added ice-cold sodium borohydride aqueous solution (0.01 M, 0.3 mL), the solution was kept under a 30° C. water bath for 2 h after stirring at 1200 rpm for 2 min to obtain the seed solution.

2 mL of 0.01 M HAuCl₄ aqueous solution, 0.4 mL of 0.01 M silver nitrate aqueous solution, 0.32 mL of 0.1 M L-ascorbic acid aqueous solution, and 0.128 mL of the above-prepared seed solution were added sequentially to CTAB aqueous solution (0.1 M, 40 mL) and left in a 30° C. water bath overnight.

The noble metal nanomaterial colloid, i.e. Au NR colloid, was obtained by centrifuging twice (7000 rpm, 10 min) and dispersed in deionized water.

2) Preparation of Plasmonic Materials (Au NR@ Cu₇S₄ Colloid):

Added CTAB aqueous solution (10 mL 0.1 M), L-ascorbic acid aqueous solution (2.5 mL, 0.1 M) and hexamethylenetetramine (HMT) aqueous solution (5 mL, 0.1 M) to 5 mL of Au NR colloid prepared in step 1) above, and thioacetamide (TAA) aqueous solution (100 μL, 0.1 M) and Cu(Ac)₂ aqueous solution (100 μL, 0.1 M) were added and mixed thoroughly by slowly up and down shaking. Placed the above mixture in an oven at 80° C. for 8 hours. After cooling down, it was centrifuged (7000 rpm, 10 min) and dispersed in deionized water to obtain Au NR@ Cu₇S₄ colloid, i.e., the plasmonic materials.

The core-shell nanostructures were synthesized by coating Cu₇S₄ on gold nanorods using thioacetamide as a sulfur source (FIGS. 2A, 2B). The lattice spacing of 0.204 nm in the core corresponds to the face-centered cubic Au(200) surface. The lattice spacing of 0.27 nm and 0.297 nm in the shell layer corresponds to the Cu₇S₄ (221) and Cu₇S₄ (212) facets, respectively (FIG. 2C). High-angle annular dark-field scanning transmission electron microscopy and energy dispersive X-ray spectroscopy element mapping images indicate that Cu and S elements are uniformly distributed around the Au core (FIG. 2D), confirming the formation of core-shell nanostructures.

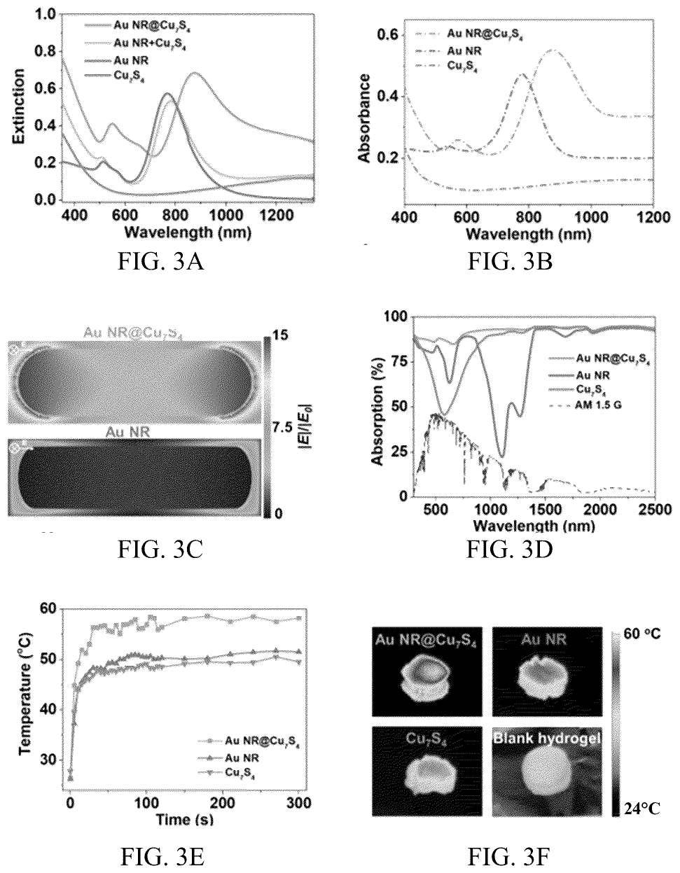

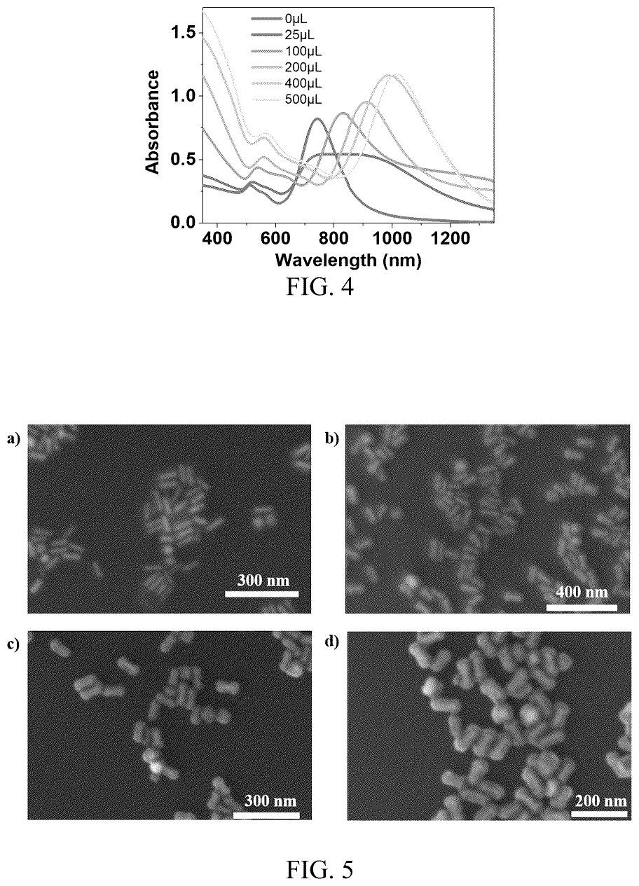

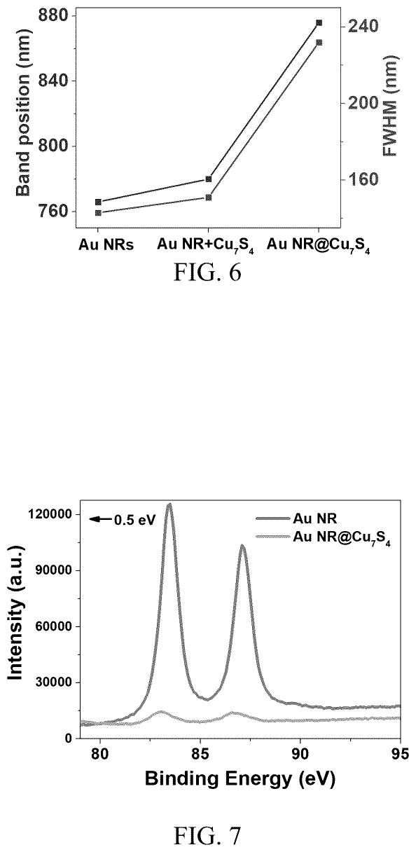

As seen in FIG. 3A, the extinction spectra of Au nanorod colloids have peaks centered at 512 nm and 766 nm, which correspond to the plasmonic oscillations of free electrons along the transverse and longitudinal axes, respectively. There are three significant differences between the extinction spectra of the plasmonic materials and Au NR colloid. First, the peak of the longitudinal plasmon resonance mode is redshifted by 110 nm and the full width at half maximum is broadened by 89 nm. Second, the intensity of both transverse and longitudinal plasmon resonance modes is increased. This is due to the fact that the peak of the plasmon resonance mode will be red-shifted and enhanced as the refractive index of the surrounding environment increases. Third, a new strong absorption appears at wavelengths above 1000 nm, which is more significant when the Cu₇S₄ shell layer is thicker (e.g., FIG. 4), where the thickness of the Cu₇S₄ shell layer can be adjusted from 5 nm to 16 nm by changing the Cu precursor addition (FIG. 5). This absorption peak is caused by the plasmonic oscillation of free holes in Cu₇S₄, as shown in FIG. 3A, and the extinction spectrum of the Cu₇S₄ nanoparticle colloid has a broad peak in the near-infrared light region. However, the extinction intensity of the physical mixture colloid of Au NR and Cu₇S₄ (Au NR+Cu₇S₄) is significantly smaller than that of the Au NR@Cu₇S₄ colloid, especially in the near-infrared light region (FIG. 3A). In addition, the peak shifts and width variations of the physical mixture colloid were smaller than those of the Au NR@ Cu₇S₄ colloid (FIG. 6). These results suggest that the interaction of Au nanorods and copper sulfide with light in Au NR@Cu₇S₄ is enhanced by the presence of each other.

To provide physical insight into the enhanced light-Au NR@ Cu₇S₄ interaction, optical simulations were performed using the finite-difference time-domain method. The absorbance spectra of Au NR, Cu₇S₄ and Au NR@ Cu₇S₄ colloids obtained from the simulations are consistent with the experiments (FIG. 3B). The electric field enhancement (|E|/|E0|) near the periphery of Au NR@ Cu₇S₄ is significantly larger than that of Au NR when excited along the longitudinal axis (FIG. 3C). These results suggest that the strong plasmon coupling between the two components of Au NR@ Cu₇S₄ is responsible for the strong absorption of NIR light by the Au NR@Cu₇S₄ colloid.

The Au 4f peak in the X-ray photoelectron spectrum of Au NR@Cu₇S₄ colloid shifts to lower energy compared with Au NR colloid (FIG. 7), indicating the strong interaction between the two components in Au NR@ Cu₇S₄ and the transfer of electrons from Cu₇S₄ to Au, which may lead to the increase of carrier concentration and enhanced absorption in Cu₇S₄. In summary, Au NR@ Cu₇S₄ exhibits a broad and strong absorption over a wide spectral range due to the combination and coupling of the absorption of the plasmonic metal and the plasmonic semiconductor.

### Example 2

### Preparation and Testing of Solar Absorber

Dissolved 8.5 g of polyvinyl alcohol and 1.5 g of chitosan in 100 mL of deionized water containing 10 mL of 1.2 M hydrochloric acid solution to obtain polyvinyl alcohol/chitosan solution.

Added 0.04 mL of 10 wt % glutaraldehyde solution and 0.5 mL of Au NR@ Cu₇S₄, Au NR, Cu₇S₄ colloid or 0.5 mL of deionized water to the above 1 mL of polyvinyl alcohol/chitosan solution and stirred for 45 min and sonicated for 30 min. After standing for 5 h, hydrogels containing Au NR@Cu₇S₄, Au NR or Cu₇S₄ and blank hydrogel were obtained.

The above hydrogels were immersed in deionized water to remove unreacted impurities. Subsequently frozen at −20° C. for two hours, thawed in deionized water at 30° C. for 30 min, and so repeated three times, and finally freeze-dried to obtain Au NR@ Cu₇S₄, Au NR or Cu₇S₄ solar absorbers and blank hydrogel. The diameter of all hydrogels was 2.2 cm.

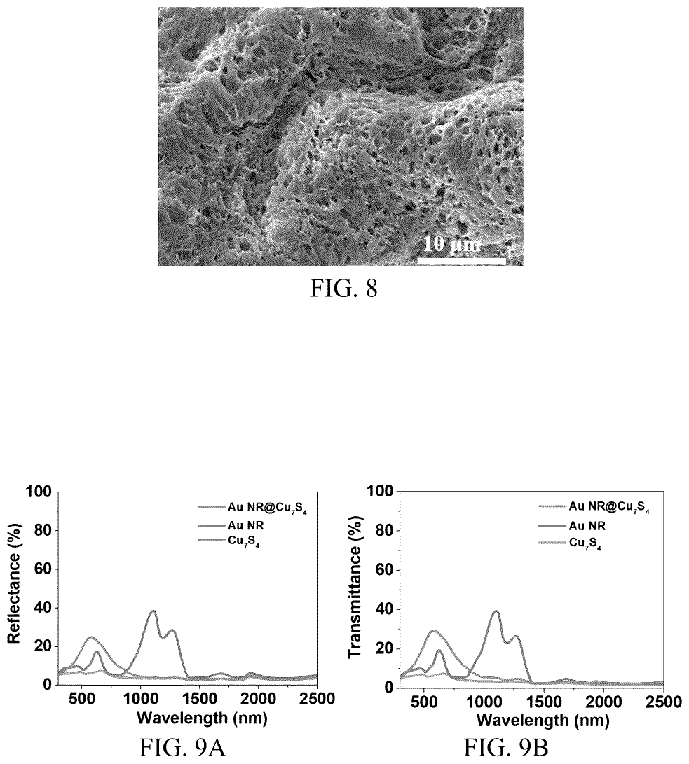

Hydrogels can accelerate water evaporation by reducing the evaporation enthalpy, therefore, Au NR@Cu₇S₄ nanomaterials were impregnated in hydrogels composed of polyvinyl alcohol and chitosan to synthesize Au NR@ Cu₇S₄ solar absorber and used for solar-driven interfacial water evaporation and seawater desalination experiments. The Au NR@ Cu₇S₄ colloid was added to a mixture solution of polyvinyl alcohol and chitosan for in situ cross-linking to form a uniformly distributed porous structure with a few microns in diameter (FIG. 8), which allows the light absorber to continuously absorb water from the water to the surface of the light absorber by capillary forces when the light absorber floats on the water surface.

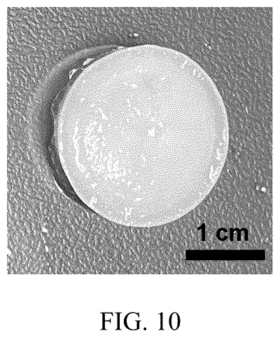

Au NR and Cu₇S₄ colloids were also incorporated into the above hydrogels as control samples, respectively. The absorption spectra of the above solar absorber are shown in FIG. 3D, and the corresponding transmission and reflection spectra are shown in FIG. 9. The blank hydrogels are pale yellow in color (FIG. 10). The Au NR solar absorber barely absorbs light from 900 nm to 1400 nm, while the Cu₇S₄ solar absorber shows only weak absorption in the range of 400 nm to 900 nm. In contrast, the Au NR@Cu₇S₄ solar absorber exhibits strong absorption in the entire solar spectrum with negligible optical loss. The loadings of Au and Cu in each of these solar absorbers mentioned above are only 28 μg cm⁻² and 18 μg cm⁻², respectively.

The excellent solar absorption of the freeze-dried Au NR@Cu₇S₄ solar absorber resulted in a rapid temperature increase to the equilibrium temperature (˜59° C.) within 80 s under 1 sun illumination (FIG. 3E), and Au NR@Cu₇S₄ heats up the lattice during its plasmon decay, effectively converting sunlight into heat energy, resulting in a significant and rapid temperature increase. The infrared thermal images of the above solar absorbers in thermal equilibrium under 1 sun illumination are shown in FIG. 3F, where the temperature of the blank hydrogel hardly increases.

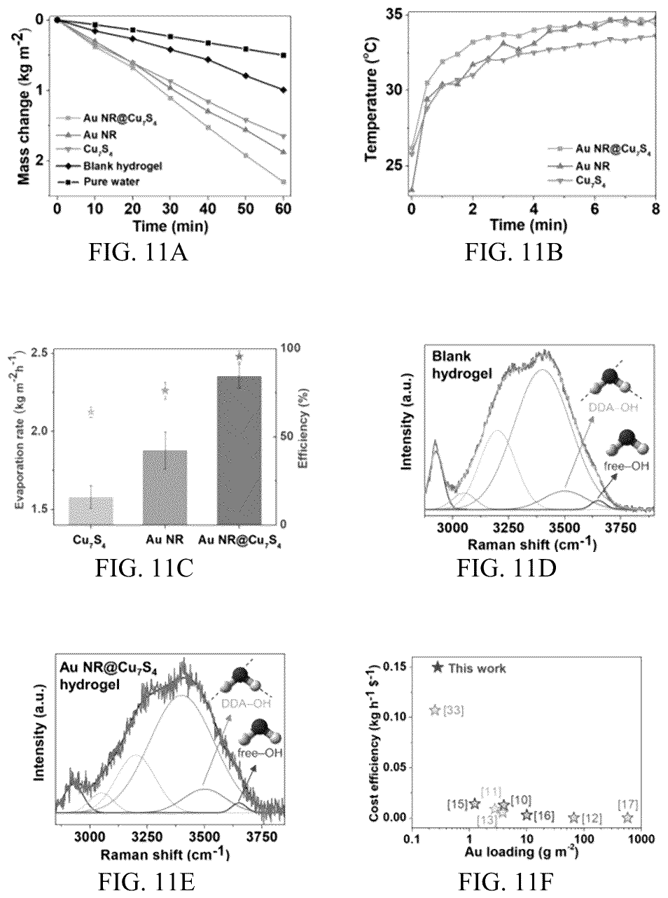

The above solar absorbers were used for solar-driven interfacial water evaporation under 1 sun illumination. As shown in FIG. 11A, the Au NR@ Cu₇S₄ solar absorber has the fastest evaporation rate: its average evaporation rate reaches 2.35 kg m⁻² h⁻¹, which is higher than that of the Au NR solar absorber (1.87 kg m⁻² h⁻¹) and Cu₇S₄ solar absorber (1.6 kg m⁻² h⁻¹). These data were measured after the temperature of the solar absorbers surface reached thermal equilibrium after 5 min (FIG. 11B). The solar-vapor energy conversion efficiency (q) of the solar absorber was calculated by equation (1) as follows:

$$η = \frac{mH}{{c}_{opt} {P}_{0}} , \qquad ( 1 )$$

Among them, m and H are evaporation rate and evaporation enthalpy, respectively; P₀ is the radiant power of one sun (1 kW m⁻²); Cₒₚₜ refers to the solar light concentration. η is only 76% for Au NR solar absorber and 64% for Cu₇S₄ solar absorber (FIG. 11C). In contrast, the η of Au NR@ Cu₇S₄ solar absorber is 95.5%, indicating its high energy utilization efficiency for solar energy.

The Au NR@ Cu₇S₄ solar absorber and deionized water with the same surface area were put into a closed container with the relative humidity maintained at 45%, Comparing the mass loss during evaporation, the evaporation enthalpy of the hydrogel can be estimated with Equation (2):

$${U}_{Input} = {m}_{H 2 O} {H}_{H 2 O} = {m}_{a} H , \qquad ( 2 )$$

Among them, m_{H2O} and H_{H2O} refer to the mass loss and evaporation enthalpy of water (2450 kJ/kg), respectively; mₐ and H refer to the mass loss and evaporation enthalpy of the solar absorber, respectively. H was estimated to be 1460 kJ/kg.

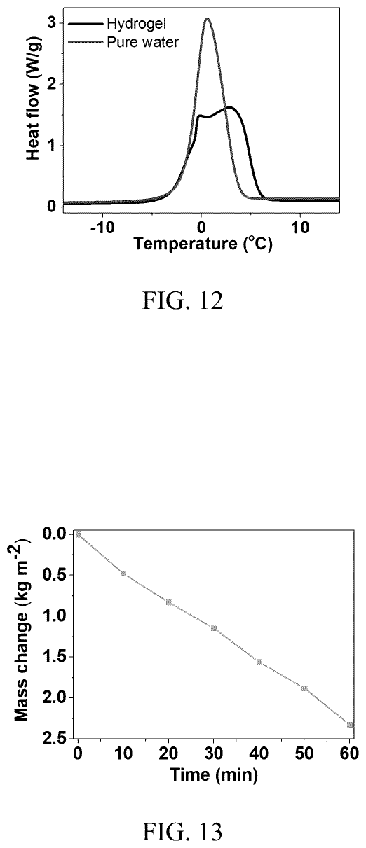

The melting curves of the blank hydrogel and deionized water by differential scanning calorimetry were significantly different (FIG. 12), indicating that the structure of water in the hydrogel was different from that of water in pure water. To explore the state of water in the hydrogels before and after impregnated with Au NR@ Cu₇S₄, their Raman spectra were tested separately (FIG. 11D, 11E). After Gaussian fitting, the Raman spectra revealed the following OH vibrational modes of water: the peaks at 3500 cm⁻¹ and 3650 cm⁻¹ correspond to double donor-single acceptor (DDA-OH) and free OH in weakly hydrogen-bonded water, respectively. It is known that these types of water molecules are intermediate water, with a weak interaction with the polymer backbone, and therefore these types of water molecules have lower evaporation enthalpies and faster evaporation rates.

Compared with the blank hydrogel, the proportion of intermediate water was basically unchanged after the incorporation of Au NR@ Cu₇S₄, indicating that the state of water in the hydrogel was almost unchanged before and after the incorporation of Au NR@ Cu₇S₄. On the other hand, the evaporation rate of the above solar absorbers with better photothermal performance is faster. Therefore, the excellent performance of Au NR@ Cu₇S₄ solar absorber in solar-driven interfacial water evaporation is attributed to the excellent solar thermal conversion ability of Au NR@ Cu₇S₄ nanomaterials. Considering that the scarcity and high cost of plasmonic noble metal nanoparticles severely limit their application in large-scale solar desalination, therefore, it is of practical value to reduce the loading of noble metals in the solar absorbers without affecting their performance. To this end, the Au cost efficiency (ξ), which indicates how many kg of water can be evaporated in 1 hour if it costs $1, is introduced as follows:

$$ζ = \frac{m}{L \times \$} , \qquad ( 3 )$$

Among them, m, L and $ refer to the evaporation rate (kg m⁻² h⁻¹), Au loading (g m⁻²) and gold price (56 $ g⁻¹), respectively. ξ for the Au NR@ Cu₇S₄ solar absorber is 0.149 kg h⁻¹ $⁻¹, which is better than the previously reported Au-based solar absorbers (FIG. 11F).

### Example 3

### Photothermal Performance and Evaporation Tests of Solar Absorber

Performed with a solar simulator with AM 1.5G filter, with light intensity calibrated by a calibrated reference cell. The ambient temperature during the evaporation experiments was about 25° C. and the relative humidity was 45-55%. Opened the top door of the analytical balance, and placed it under the solar simulator, and adjusted the solar light intensity to 1 kW m⁻². A flat beaker with the same diameter as the light absorber was filled with water, and the swollen solar absorber was floated on the water surface and placed on the analytical balance as described above, and the change in the mass of the water from the start of light exposure was automatically recorded using the balance.

The solar absorber of present disclosure exhibits strong light absorption in almost the entire solar spectrum with only a small amount of gold loading (28 μg cm⁻²) without sacrificing absorption intensity. When used for solar-driven interfacial desalination, this solar absorber has an evaporation rate of up to 2.35 kg m⁻² h⁻¹ and an energy conversion efficiency of 95.5%, which enables effective desalination of seawater.

### Example 4

### Desalination Performance Test

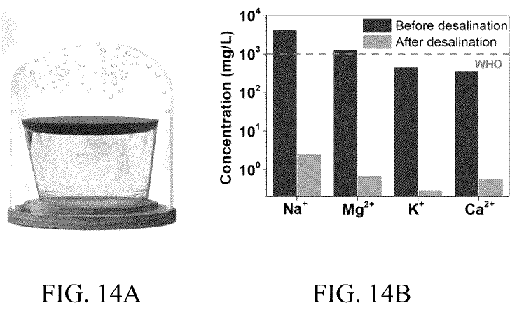

The desalination performance of the Au NR@Cu₇S₄ solar absorber was tested by collecting seawater in the southern waters of Hong Kong Island on Jul. 15, 2021, conducting solar-driven interfacial seawater desalination experiments, and its seawater evaporation rate was almost the same as the water evaporation rate (FIG. 13). The condensate was collected (experiments are shown in FIG. 14A) and the concentrations of four ions (Na⁺, Mg²⁺, Ca²⁺, K⁺) in the raw seawater and the desalinated condensate were measured by inductively coupled plasma mass spectrometry. Their concentrations were reduced from 4254, 1305, 371 and 456 mg L⁻¹ to 2.7, 0.7, 0.6 and 0.3 mg L⁻¹, respectively (FIG. 14B), all within the salinity limits for drinking water set by the World Health Organization (WHO). These results indicate that Au NR@Cu₇S₄ solar absorber has excellent desalination capabilities and provides a convenient and portable access to fresh water for seafarers and seaside residents.

The above exemplary embodiments of the present disclosure have been described. However, the scope of protection of the present application is not limited to the above-mentioned embodiments. Any modification, equivalent replacement, improvement, etc. made by a person skilled in the art within the spirit and principles of the present disclosure shall be included in the scope of protection of the present application.

1. A plasmonic material, wherein the material has a core-shell structure in which the core is a noble metal nanomaterial and the shell layer is non-stoichiometric copper sulfide with the general formula Cu₂₋ₓS, 0<x≤1.

2. The plasmonic materials according to claim 1, wherein the copper sulfide has the chemical formula Cu₇S₄ or CuS.

3. The plasmonic materials according to claim 1, wherein the shell layer has a thickness of 5 nm-16 nm.

4. A method for preparing the plasmonic materials as claimed in claim 1, wherein the method comprises the steps of:
1) preparing a noble metal nanomaterial colloid;
2) adding raw materials for preparing copper sulfide to the noble metal nanomaterial colloid prepared in step 1), reacting, and obtaining the plasmonic materials.

5. The method according to claim 4, wherein the step 1) comprises:
11) mixing an aqueous solution of the noble metal compound with an aqueous solution of a cationic ammonium compound, adding it to an aqueous solution of a reducing agent, stirring and keeping it for a period of time to obtain a seed solution;
12) adding the aqueous solution of the noble metal compound, the aqueous solution of silver nitrate, the aqueous solution of the metal ion complexing agent and the seed solution prepared above to the aqueous solution of the cationic ammonium compound in turn, standing, centrifuging and dispersing in water to obtain the noble metal nanomaterial colloid.

6. The method according to claim 4, wherein the step 2) comprises:
adding an aqueous solution of cetyltrimethylammonium bromide, an aqueous solution of L-ascorbic acid and an aqueous solution of hexamethylenetetramine to the noble metal nanomaterial colloid, adding an aqueous solution of thioacetamide and an aqueous solution of Cu(Ac)₂ and slowly shaking up and down to mix, placing the resulting mixture in an oven for a period of time, cooling down, centrifuging and dispersing in deionized water to obtain the plasmonic materials.

7. A solar absorber, wherein it comprises the plasmonic materials as claimed in claim 1.

8. A solar absorber according to claim 7, wherein the solar absorber is a complex of the plasmonic materials and a hydrogel.

9. A method of preparing a solar absorber according to claim 7, wherein the preparation method comprises:
dispersing the plasmonic materials in water to obtain a plasmonic material colloid;
blending the plasmonic material colloid into the raw material for preparing the hydrogel, and cross-linking the gelation in situ to obtain the solar absorber.

10. Applications of the plasmonic materials according to claim 1 in seawater desalination.
